(19) United States
(12) Patent Application Publication
(10) Pub. No.: US 2025/0379483 A1
(43) Pub. Date: Dec. 11, 2025

(54) CIRCUIT-INTEGRATED MOTOR

(71) Applicant: MIKUNI CORPORATION, Tokyo (JP)

(72) Inventors: Ryosuke DAKIISHI, Takizawa-shi (JP); Kan OYAMADA, Takizawa-shi (JP)

(21) Appl. No.: 19/189,372

(22) Filed: Apr. 25, 2025

(30) Foreign Application Priority Data
Jun. 7, 2024 (JP) 2024-092684

(51) Int. Cl. H02K 5/10; H02K 11/33

(52) U.S. Cl. CPC H02K 5/10; H02K 11/33; H02K 2211/03

(57) ABSTRACT

A circuit-integrated motor includes: a motor; a control board; and a casing including a partition part dividing a board chamber for housing the control board from a placement space for the motor, and a board cover disposed opposite the partition part with the control board interposed therebetween. On an outer peripheral side of the control board, an opposite surface of the partition part includes: a contact region in contact with an outer peripheral edge portion of the board cover; and an outer peripheral region formed with a seal groove recessed from the contact region. The circuit-integrated motor 1 further includes an adhesive sealant filled into the seal groove of the partition part to seal a gap between the partition part and the board cover.

### TECHNICAL FIELD

The present disclosure relates to a circuit-integrated motor in which a motor and a control unit (control board) are integrated into a single module.

### BACKGROUND

Conventionally, a circuit-integrated motor has been known in which a motor and a control unit are integrated into a single module. In the circuit-integrated motor, in general, a control board is housed in a board chamber separated from a motor placement space. Therefore, a casing of a typical circuit-integrated motor is composed of multiple parts including a board cover, and the board chamber is formed by attaching the board cover after the control board is assembled.

For example, Patent Document 1 describes, as a part of an inverter-integrated electric compressor, a circuit-integrated motor where an inverter housing part is formed on an outer peripheral portion of a motor housing in which an electric motor is housed, and an inverter device is installed within the inverter housing part.

In the circuit-integrated motor described in Patent Document 1, the inverter device is installed in the inverter housing part formed on the outer peripheral portion of the motor housing, and then the inverter housing part is sealed by attaching a lid body. At this time, a liquid sealant is filled into a groove disposed in a flange portion around an opening of the inverter housing part and then cured, thereby hermetically sealing a joint surface between the flange portion and the lid body.

### Citation List

### Patent Literature

Patent Document 1: JP2010-59941A

### SUMMARY

Meanwhile, in a circuit-integrated motor, if a corrosive liquid (for example, water containing an electrolyte) adheres to gaps between multiple casing parts including a board cover, it can cause gap corrosion.

In this regard, Patent Document 1 describes that a flow direction of a liquid sealant is restricted to an inner peripheral side to improve waterproof property of the inverter housing part, by making a width dimension L1 of a joint surface formed on an inner peripheral side of the groove of the flange smaller than a width dimension L2 of a joint surface formed on an outer peripheral side of the groove (L1<L2).

However, Patent Document 1 does not describe any specific measures for improving gap corrosion resistance.

In view of the above, an object of at least some embodiments of the present invention is to provide a circuit-integrated motor with excellent gap corrosion resistance.

A circuit-integrated motor according to at least some embodiments of the present invention, includes: a motor; a control board for controlling the motor; a casing including a partition part dividing a board chamber for housing the control board from a placement space for the motor, and a board cover disposed opposite the partition part with the control board interposed therebetween. On an outer peripheral side of the control board, an opposite surface of the partition part to the board cover includes: a contact region in contact with an outer peripheral edge portion of the board cover; and an outer peripheral region located on an outer peripheral side of the contact region and formed with a seal groove recessed from the contact region. The circuit-integrated motor further includes an adhesive sealant filled into the seal groove of the partition part to seal a gap between the partition part and the board cover. The opposite surface of the partition part to the board cover has a maximum protrusion height H_max from a groove bottom of the seal groove toward the board cover in the outer peripheral region, which is less than a protrusion height H_ref from the groove bottom toward the board cover in the contact region.

According to at least some embodiments of the present invention, since H_max<H_ref, it is possible to control a flow direction of the liquid gasket applied to the seal groove within the seal groove, such that the liquid gasket is pushed out to the outer peripheral side. Therefore, the adhesive sealant formed by solidification of the liquid gasket effectively seals a gap at a mating surface between the board cover and the partition part, making it possible to improve gap corrosion resistance of the circuit-integrated motor.

Further, compared to a case where the flow direction of the liquid gasket within the seal groove is controlled to the inner peripheral side, a sufficient amount of the liquid gasket can be supplied to an outermost peripheral portion of the gap between the board cover and the partition part, making it possible to effectively suppress gap corrosion in the circuit-integrated motor.

### BRIEF DESCRIPTION OF DRAWINGS

FIG. 1A is a schematic view showing a configuration of a circuit-integrated motor according to an embodiment.

FIG. 1B is a schematic view showing a configuration of a circuit-integrated motor according to another embodiment.

FIG. 1C is a schematic view showing a configuration of a circuit-integrated motor according to still another embodiment.

FIG. 2A is a schematic cross-sectional view showing a configuration of an adhesive sealant and a seal groove according to an embodiment.

FIG. 2B is a schematic cross-sectional view showing a configuration of an adhesive sealant and a seal groove according to another embodiment.

FIG. 2C is a schematic cross-sectional view showing a configuration of an adhesive sealant and a seal groove according to still another embodiment.

FIG. 2D is a schematic cross-sectional view showing a configuration of an adhesive sealant and a seal groove according to yet another embodiment.

FIG. 3A is an exploded perspective view showing a configuration around a fastening portion between a partition part and a board cover according to an embodiment.

FIG. 3B is an exploded perspective view showing the configuration around the fastening portion between the partition part and the board cover according to another embodiment.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

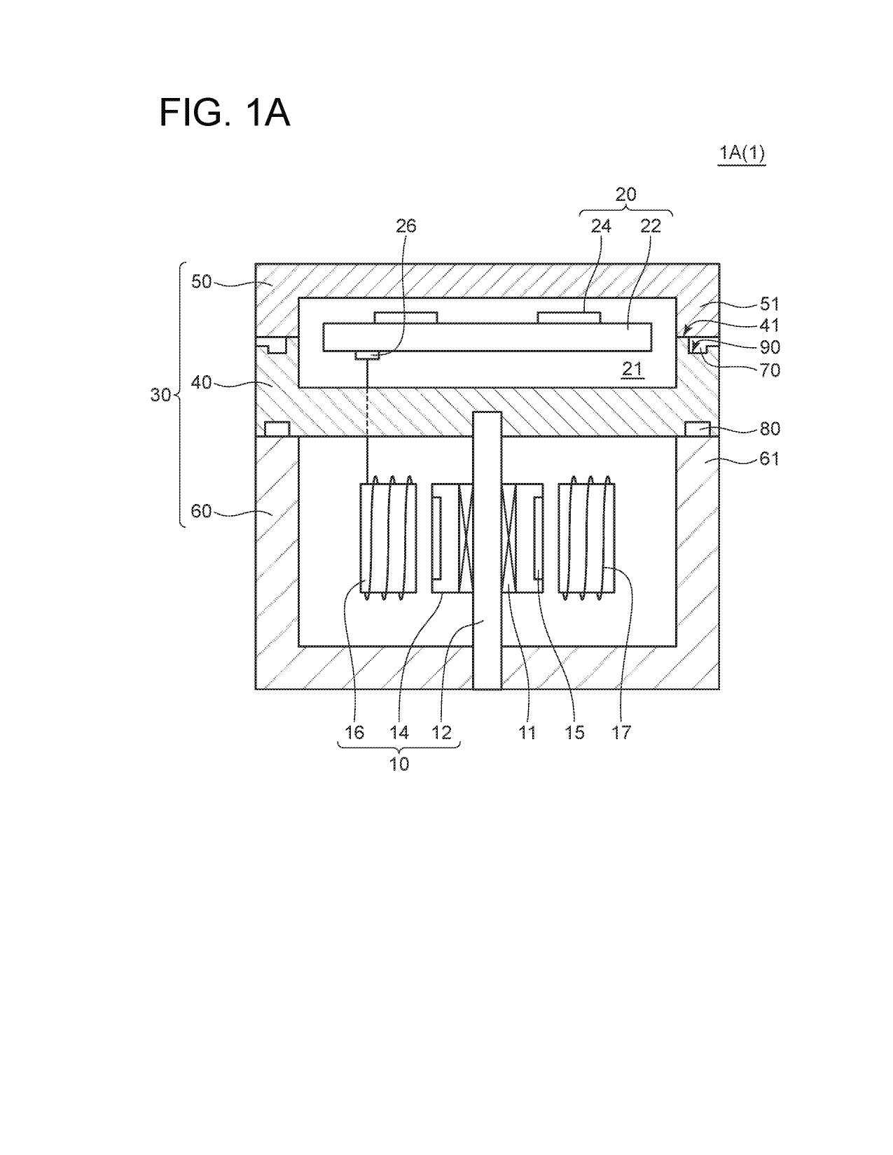

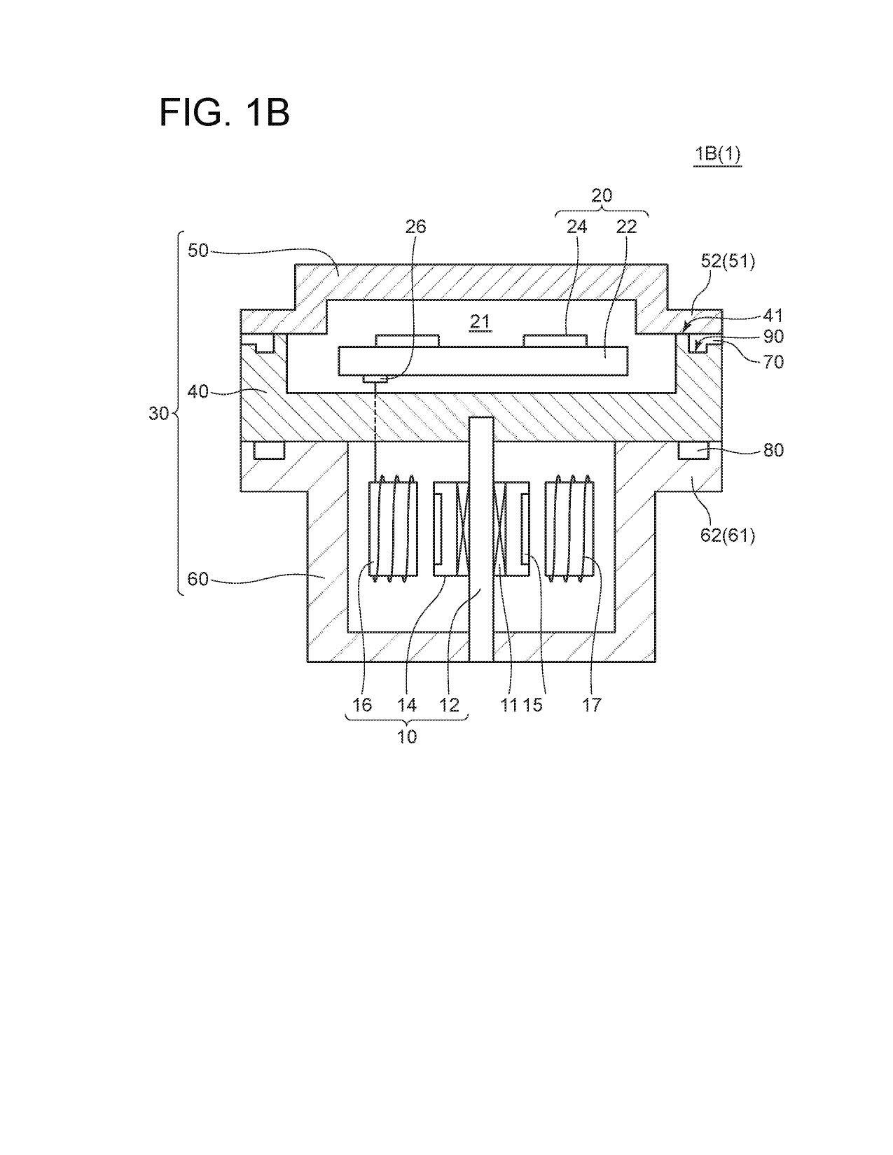

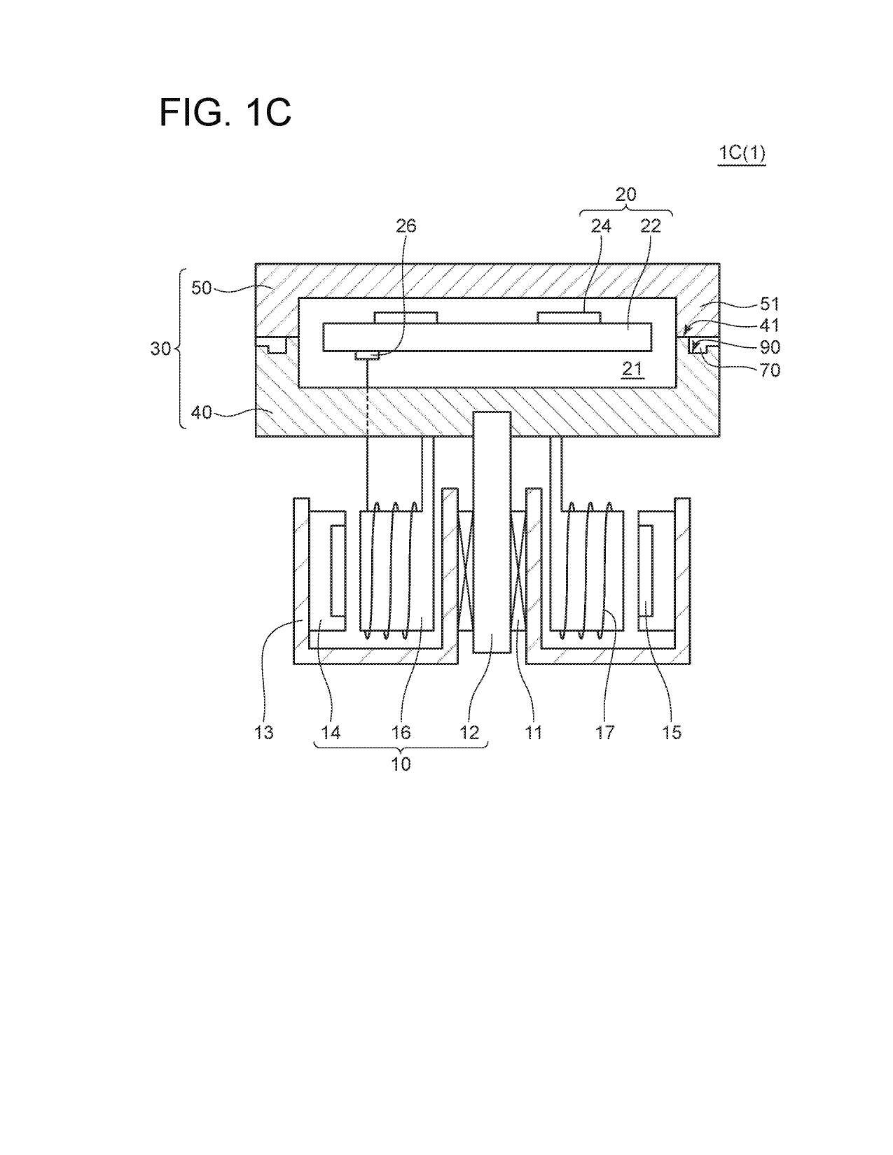

FIG. 1A is a schematic view showing a configuration of a circuit-integrated motor according to an embodiment. FIG. 1B is a schematic view showing a configuration of a circuit-integrated motor according to another embodiment. FIG. 1C is a schematic view showing a configuration of a circuit-integrated motor according to still another embodiment.

In some embodiments, as shown in FIGS. 1A to 1C, a circuit-integrated motor 1 (1A to 1C) includes a motor 10, a control board 20 for controlling the motor 10, and a casing 30 covering at least the control board 20.

The motor 10 includes a rotor 14 rotatably supported by a bearing 11, and a stator 16 disposed opposite the rotor 14.

The rotor 14 includes a magnet 15 facing the stator 16 across a gap (magnetic gap). The stator 16 includes a coil wire 17 for generating a magnetic field magnetically interacting with the magnet 15. In the exemplary embodiments shown in FIGS. 1A to 1C, the rotor 14 and the stator 16 face each other across the magnetic gap in the radial direction. In another embodiment, the rotor 14 and the stator 16 face each other across the magnetic gap in the axial direction.

In the exemplary embodiments shown in FIGS. 1A to 1C, the motor 10 includes a support shaft 12 for rotatably supporting the rotor 14 via the bearing 11. The support shaft 12 is a stationary member fixed to the casing 30 (a partition part 40 described later). In another embodiment, the motor 10 includes a rotational shaft rotating together with the rotor 14, and the rotational shaft is supported in the casing 30 (the partition part 40 described later) via a bearing.

In some embodiments, as shown in FIGS. 1A and 1B, the motor 10 is an inner rotor motor in which the rotor 14 is located radially inward of the stator 16. In some other embodiments, as shown in FIG. 1C, the motor 10 is an outer rotor motor in which the rotor 14 is located radially outward of the stator 16.

In the exemplary embodiment shown in FIG. 1C, the motor 10 has a rotor holding part 13 for connecting the rotor 14 located radially outward of the stator 16 to the support shaft 12 located radially inward of the stator 16 and holding the rotor 14.

The control board 20 includes a printed wiring board 22, and an electronic component 24 mounted on the printed wiring board 22. The electronic component 24 may include a semiconductor device forming an inverter circuit for controlling power supplied to the coil wire 17 of the motor 10.

Further, the control board 20 has a terminal 26 electrically connected to the coil wire 17.

In some embodiments, as shown in FIGS. 1A to 1C, the casing 30 includes the partition part 40, and a board cover 50 disposed opposite the partition part 40 with the control board 20 interposed therebetween.

The partition part 40 divides the board chamber 21 for housing the control board 20 from a placement space for the motor 10. The partition part 40 is located between the control board 20 and the motor 10 in the axial direction of the circuit-integrated motor 1 (1A to 1C).

The board cover 50 is attached to the partition part 40. In a state in which the board cover 50 is attached to the partition part 40, an outer peripheral edge portion 51 of the board cover 50 is in contact with an opposite surface 41 of the partition part 40 to the board cover 50 on an outer peripheral side of the control board 20. The partition part 40 and the board cover 50 define the board chamber 21.

In the exemplary embodiment shown in FIG. 1B, the outer peripheral edge portion 51 of the board cover 50 is a flange 52 extending radially outward.

At least either of the partition part 40 or the board cover 50 is made of a material that can undergo a corrosive reaction by a corrosive liquid (for example, water containing an electrolyte).

For example, the partition part 40 may be made of resin, and the board cover 50 may be made of aluminum or an aluminum alloy. In this case, aluminum or the aluminum alloy is a material that can undergo the corrosive reaction by the corrosive liquid (for example, the water containing the electrolyte). Therefore, at an interface between an adhesive sealant 70 (70A to 70D) described later and the outer peripheral edge portion 51 of the board cover 50, the corrosive reaction of aluminum or the aluminum alloy by the corrosive liquid occurs, and gap corrosion can become a problem.

In the embodiments shown in FIGS. 1A and 1B, the casing 30 includes a motor cover 60 in addition to the partition part 40 and the board cover 50. The motor cover 60 is attached to the partition part 40 on an opposite side of the partition part 40 from the board cover 50 in the axial direction of the circuit-integrated motor 1 (1A, 1B). In a state in which the motor cover 60 is attached to the partition part 40, an outer peripheral edge portion 61 of the motor cover 60 is in contact with the partition part 40. The partition part 40 and the motor cover 60 form a motor chamber for housing the motor 10. In the exemplary embodiment shown in FIG. 1B, the outer peripheral edge portion 61 of the motor cover 60 is a flange 62 extending radially outward.

In contrast, in the embodiment shown in FIG. 1C, the casing 30 does not include the motor cover 60. Instead, in the circuit-integrated motor 1C, a main portion of the motor 10 is covered by the rotor holding part 13 which is a rotational part.

In some embodiments, as shown in FIGS. 1A to 1C, the circuit-integrated motor 1 (1A to 1C) includes the adhesive sealant 70 for sealing a gap between the partition part 40 and the board cover 50 as components of the casing 30. The adhesive sealant 70 is filled into a seal groove 90 disposed in the opposite surface 41 of the partition part 40 to the board cover 50, on the outer peripheral side of the control board 20.

In the exemplary embodiments shown in FIGS. 1A and 1B, the circuit-integrated motor 1A, 1B includes, in addition to the above-described adhesive sealant 70 for sealing the gap between the partition part 40 and the board cover 50, an adhesive sealant 80 for sealing a gap between the partition part 40 and the motor cover 60.

The adhesive sealant 70, 80 is a solidified liquid gasket. The liquid gasket for forming the adhesive sealant 70, 80 is not particularly limited, but for example, a liquid gasket made of a silicone-based or acrylic-based resin composition can be used.

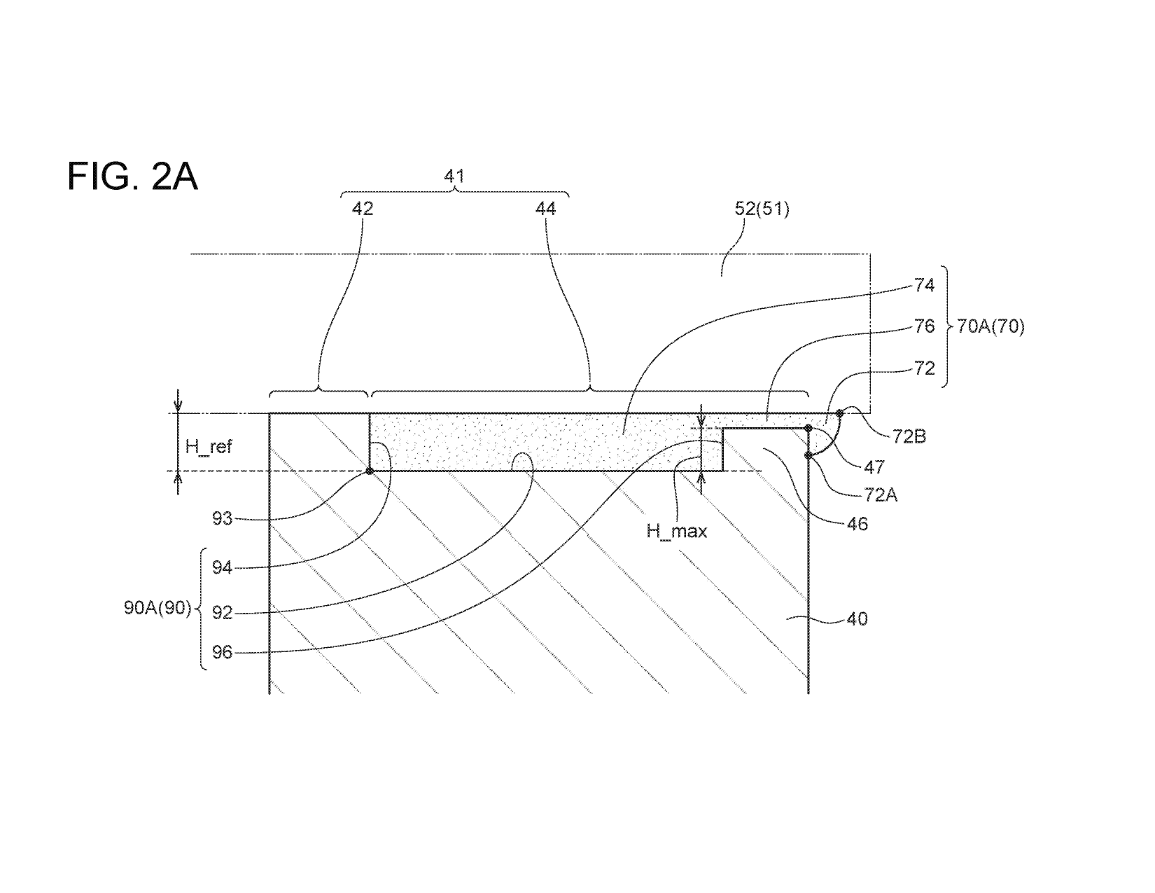

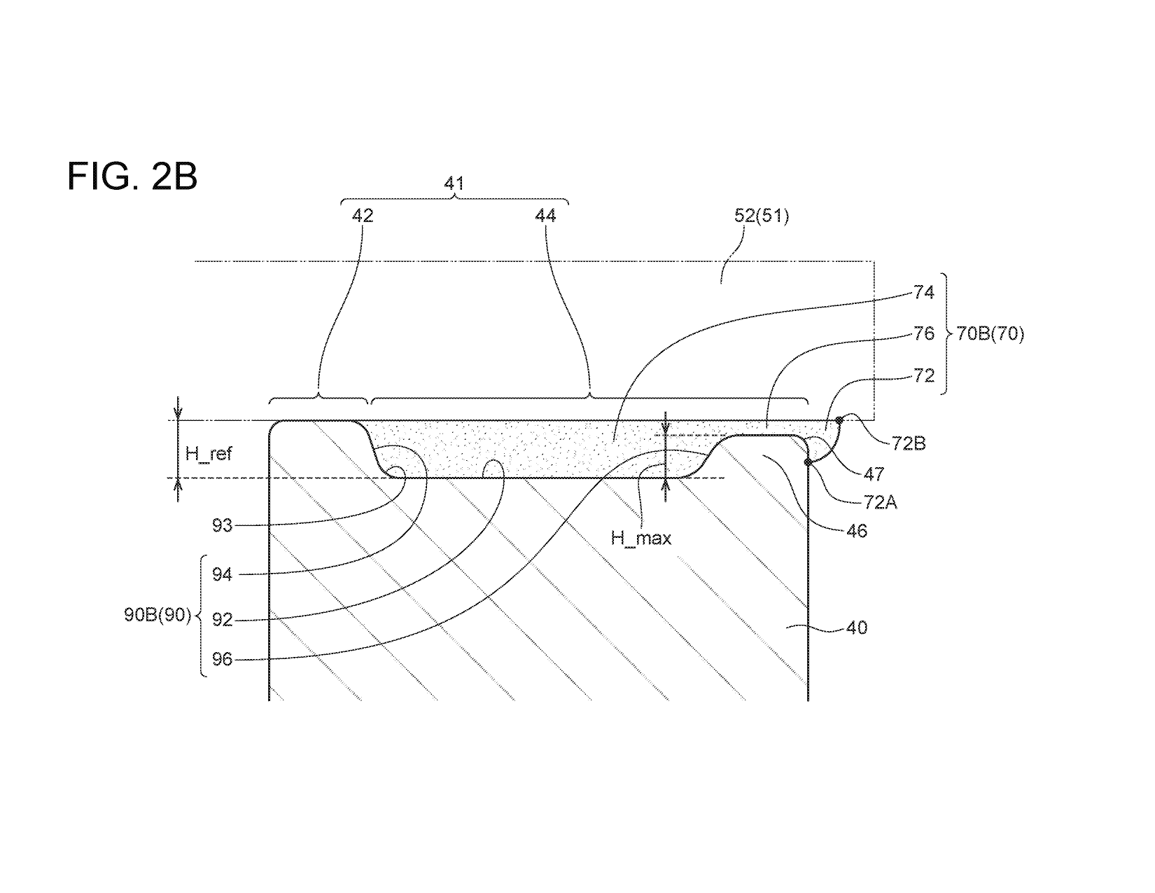

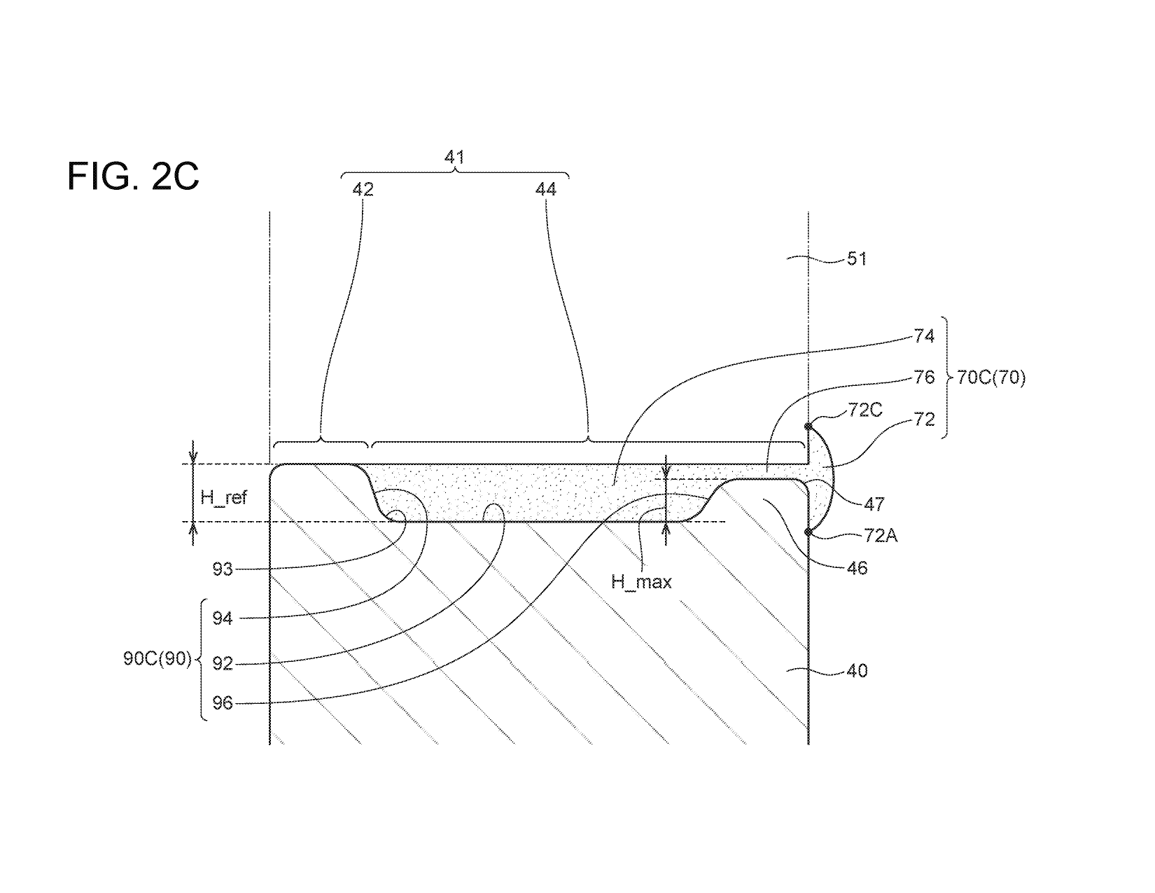

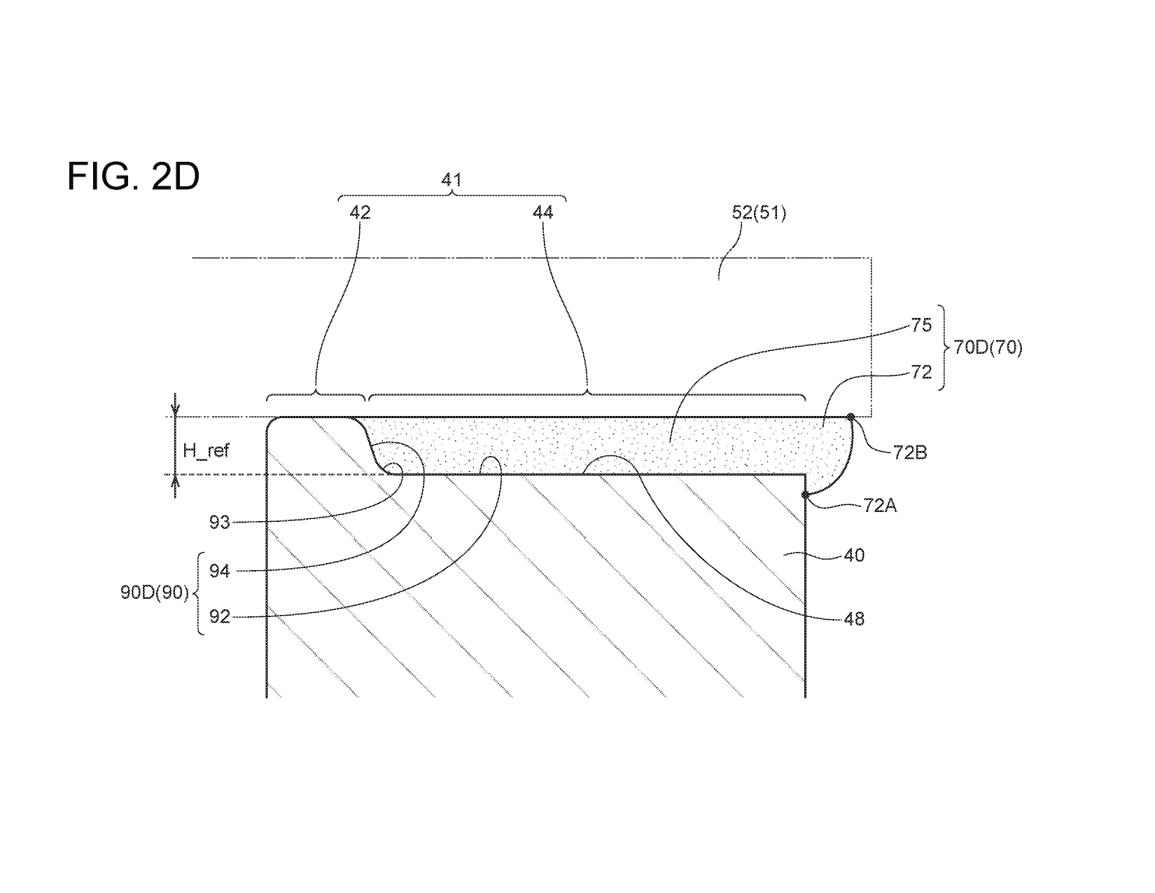

Next, the configuration of the adhesive sealant 70 and the seal groove 90 in some embodiments will be described with reference to FIGS. 2A to 2D.

FIG. 2A is a schematic cross-sectional view showing the configuration of the adhesive sealant 70A and a seal groove 90A according to an embodiment. FIG. 2B is a schematic cross-sectional view showing the configuration of the adhesive sealant 70B and a seal groove 90B according to another embodiment. FIG. 2C is a schematic cross-sectional view showing the configuration of the adhesive sealant 70C and a seal groove 90C according to still another embodiment. FIG. 2D is a schematic cross-sectional view showing the configuration of the adhesive sealant 70D and a seal groove 90D according to yet another embodiment.

In FIGS. 2A to 2D, the outer peripheral edge portion 51 (flange 52) of the board cover 50 is indicated by a double-dotted chain line in order to highlight the adhesive sealant 70 (70A to 70D) and the seal groove 90.

As shown in FIGS. 2A to 2D, the opposite surface 41 of the partition part 40 to the board cover 50 includes a contact region 42 in contact with the outer peripheral edge portion 51 of the board cover 50, and an outer peripheral region 44 located on an outer peripheral side of the contact region 42, on the outer peripheral side of the control board 20. In the outer peripheral region 44 of the opposite surface 41, the seal groove 90 (90A to 90D) is formed which is recessed from the contact region 42. The adhesive sealant 70 (70A to 70D) is filled into the seal groove 90 (90A to 90D) disposed in the outer peripheral region 44 of the opposite surface 41. The adhesive sealant 70 (70A to 70D) filled into the seal groove 90 (90A to 90D) seals a gap between the opposite surface 41 of the partition part 40 and the outer peripheral edge portion 51 of the board cover 50.

In some embodiments, the opposite surface 41 of the partition part 40 has a maximum protrusion height H_max from a groove bottom 92 of the seal groove 90 (90A to 90D) toward the board cover 50 in the outer peripheral region 44, which is less than a protrusion height H_ref from the groove bottom 92 toward the board cover 50 in the contact region 42. That is, with regard to the axial direction of the circuit-integrated motor 1, of the opposite surface 41 of the partition part 40 to the outer peripheral edge portion 51 of the board cover 50, the contact region 42 of the opposite surface 41 is located closest to the board cover 50.

Therefore, in a state in which the outer peripheral edge portion 51 of the board cover 50 is in contact with the contact region 42, a gap is formed between the outer peripheral region 44 of the opposite surface 41 and the outer peripheral edge portion 51 of the board cover 50.

As described above, since the gap is present between the outer peripheral region 44 and the outer peripheral edge portion 51 of the board cover 50 in the state in which the outer peripheral edge portion 51 of the board cover 50 is in contact with the contact region 42, the liquid gasket applied to the seal groove 90 (90A to 90D) flows toward the outer peripheral side when the board cover 50 is attached to the partition part 40.

Therefore, if the appropriate amount of the liquid gasket is applied to the seal groove 90 (90A to 90D), as shown in FIGS. 2A to 2D, the liquid gasket solidifies in a state in which the liquid gasket protrudes from the gap between the outer peripheral region 44 of the opposite surface 41 and the outer peripheral edge portion 51 of the board cover 50 toward the outer peripheral side, and forms a bulging portion 72 of the adhesive sealant 70 (70A to 70D). The bulging portion 72 refers to a portion of the adhesive sealant 70 (70A to 70D), which bulges from the gap between the partition part 40 and the board cover 50 to the outer peripheral side.

When the adhesive sealant 70 (70A to 70D) includes the bulging portion 72, an outermost peripheral portion of the gap between the board cover 50 and the partition part 40 is sealed with the adhesive sealant 70 (70A to 70D), making it possible to suppress adhesion of the corrosive liquid (for example, the water containing the electrolyte) that causes gap corrosion.

When a CCT test (Cyclic Corrosion Test) was carried out on a sample having the board cover 50 made of the aluminum alloy and the adhesive sealant 70 including the bulging portion 72, no gap corrosion occurred up to 200 cycles.

In contrast, in a sample of a comparative example, which has a conventional structure where an adhesive sealant does not have a bulging portion, gap corrosion occurred after 150 cycles.

One of causes of gap corrosion is that the corrosive liquid may adhere to the outermost peripheral portion of the gap between the board cover and the partition part and remain there for a long period of time, which may gradually progress a corrosive reaction at an interface between the adhesive sealant and the board cover or the partition part.

In this regard, the adhesive sealant 70 can prevent, by the bulging portion 72, the adhesion of the corrosive liquid to the outermost peripheral portion of the gap between the board cover 50 and the partition part 40. Therefore, the corrosive liquid that causes gap corrosion has less opportunity to enter the interface between the board cover 50 and the adhesive sealant 70, which is considered to be why the good CCT test result was obtained.

In the exemplary embodiments shown in FIGS. 2A, 2B, and 2D, the outer peripheral edge portion 51 of the board cover 50 protrudes radially outward from the partition part 40. Therefore, a contour of the bulging portion 72 is defined by a curve connecting a first point 72A present on an outer peripheral surface of the partition part 40 and a second point 72B present on a lower surface of the outer peripheral edge portion 51 of the board cover 50.

Thus, when the outer peripheral edge portion 51 of the board cover 50 extends radially outward of the partition part 40, if the circuit-integrated motor 1 is used with a posture in which the board cover 50 is located above the partition part 40, the outer peripheral edge portion 51 of the board cover 50 functions as an eave, making it possible to more effectively prevent the adhesion of the corrosive liquid.

In contrast, in the exemplary embodiment shown in FIG. 2C, an outer peripheral surface of the outer peripheral edge portion 51 of the board cover 50 is substantially aligned with the outer peripheral surface of the partition part 40 in the radial direction. Therefore, the contour of the bulging portion 72 is defined by a curve connecting the first point 72A present on the outer peripheral surface of the partition part 40 and a third point 72C present on the outer peripheral surface of the outer peripheral edge portion 51 of the board cover 50.

In some embodiments, as shown in FIGS. 2A to 2C, the partition part 40 has an outer peripheral protruding portion 46 protruding from the groove bottom 92 of the seal groove 90 (90A to 90C) toward the board cover 50, in the outer peripheral region 44 of the opposite surface 41. In this case, the maximum protrusion height H_max of the opposite surface 41 from the groove bottom 92 toward the board cover 50 is a protrusion height of the outer peripheral protruding portion 46 from the groove bottom 92.

In the embodiment shown in FIG. 2A, a corner portion 47 of the outer peripheral protruding portion 46 on the outer peripheral side is not curved but is a discontinuous corner. In contrast, in the embodiments shown in FIGS. 2B and 2C, the corner portion 47 of the outer peripheral protruding portion 46 on the outer peripheral side is a curved corner. When the corner portion 47 of the outer peripheral protruding portion 46 on the outer peripheral side has a curved shape, a distance between the opposite surface 41 of the partition part 40 and the outer peripheral edge portion 51 of the board cover 50 gradually increases toward the outer peripheral side in the curved corner portion 47.

In contrast, in some other embodiments, as shown in FIG. 2D, the outer peripheral region 44 of the opposite surface 41 of the partition part 40 is formed by a flat surface 48. That is, the opposite surface 41 of the partition part 40 is the flat surface 48 in the outer peripheral region 44. The flat surface 48 forms the groove bottom 92 of the seal groove 90 (90D) and reaches an outer peripheral edge of the partition part 40. Therefore, at any position within the outer peripheral region 44, a height of the opposite surface 41 (flat surface 48) coincides with the groove bottom 92, and the maximum protrusion height H_max of the opposite surface 41 from the groove bottom 92 toward the board cover 50 is substantially zero.

In some embodiments, as shown in FIGS. 2A to 2C, the adhesive sealant 70 (70A to 70C) extends from the seal groove 90 (90A to 90C) beyond the outer peripheral protruding portion 46, bulges from the gap between the partition part 40 and the board cover 50 to the outer peripheral side, and forms the aforementioned bulging portion 72.

The adhesive sealant 70 (70A to 70C) includes a thickest portion 74 located between the groove bottom 92 of the seal groove 90 (90A to 90C) and the outer peripheral edge portion 51 of the board cover 50, and a thinnest portion 76 located between the outer peripheral protruding portion 46 and the outer peripheral edge portion 51 of the board cover 50. A thickness of the adhesive sealant 70 (70A to 70C) is maximum in the thickest portion 74 and minimum in the thinnest portion 76, if the bulging portion 72 is not taken into account. The thinnest portion 76 of the adhesive sealant 70 (70A to 70C) is located between the thickest portion 74 and the bulging portion 72.

In contrast, in some other embodiments, as shown in FIG. 2D, the adhesive sealant 70 (70D) includes a body portion 75 of constant thickness, which is located between the groove bottom 92 of the seal groove 90 (90D) and the outer peripheral edge portion 51 of the board cover 50. The body portion 75 of the adhesive sealant 70 (70D) is located on an inner peripheral side of the bulging portion 72.

The seal groove 90 (90A to 90D) is defined by at least the groove bottom 92 and an inner-peripheral-side groove wall 94. The inner-peripheral-side groove wall 94 is located between the groove bottom 92 and the contact region 42 of the opposite surface 41 of the partition part 40, and defines a boundary on an inner peripheral side of the seal groove 90 (90A to 90D).

In the embodiments shown in FIGS. 2A to 2C, the seal groove 90 (90A to 90D) is defined by the groove bottom 92, the inner-peripheral-side groove wall 94, and an outer-peripheral-side groove wall 96. The outer-peripheral-side groove wall 96 is located on an outer peripheral side of the groove bottom 92, and defines a boundary on an outer peripheral side of the seal groove 90 (90A to 90D). The outer-peripheral-side groove wall 96 is formed by an inner peripheral surface of the above-described outer peripheral protruding portion 46.

In contrast, in the embodiment shown in FIG. 2D, the partition part 40 does not have the outer peripheral protruding portion 46, and therefore the seal groove 90 (90D) is defined only by the groove bottom 92 and the inner-peripheral-side groove wall 94 and is open on the outer peripheral side.

In some embodiments, as shown in FIGS. 2A to 2D, a connection 93 between the inner-peripheral-side groove wall 94 and the groove bottom 92 is formed by a concave curved surface. In the connection 93 between the inner-peripheral-side groove wall 94 and the groove bottom 92, the distance between the opposite surface 41 of the partition part 40 and the outer peripheral edge portion 51 of the board cover 50 gradually increases toward the outer peripheral side.

The configuration of the adhesive sealant 70 (70A to 70D) and the seal groove 90 (90A to 90D), which is described above with reference to FIGS. 2A to 2D, may be applied around the entire circumference of the partition part 40 or may be applied to a circumferential range excluding a fastening portion between the partition part 40 and the board cover 50.

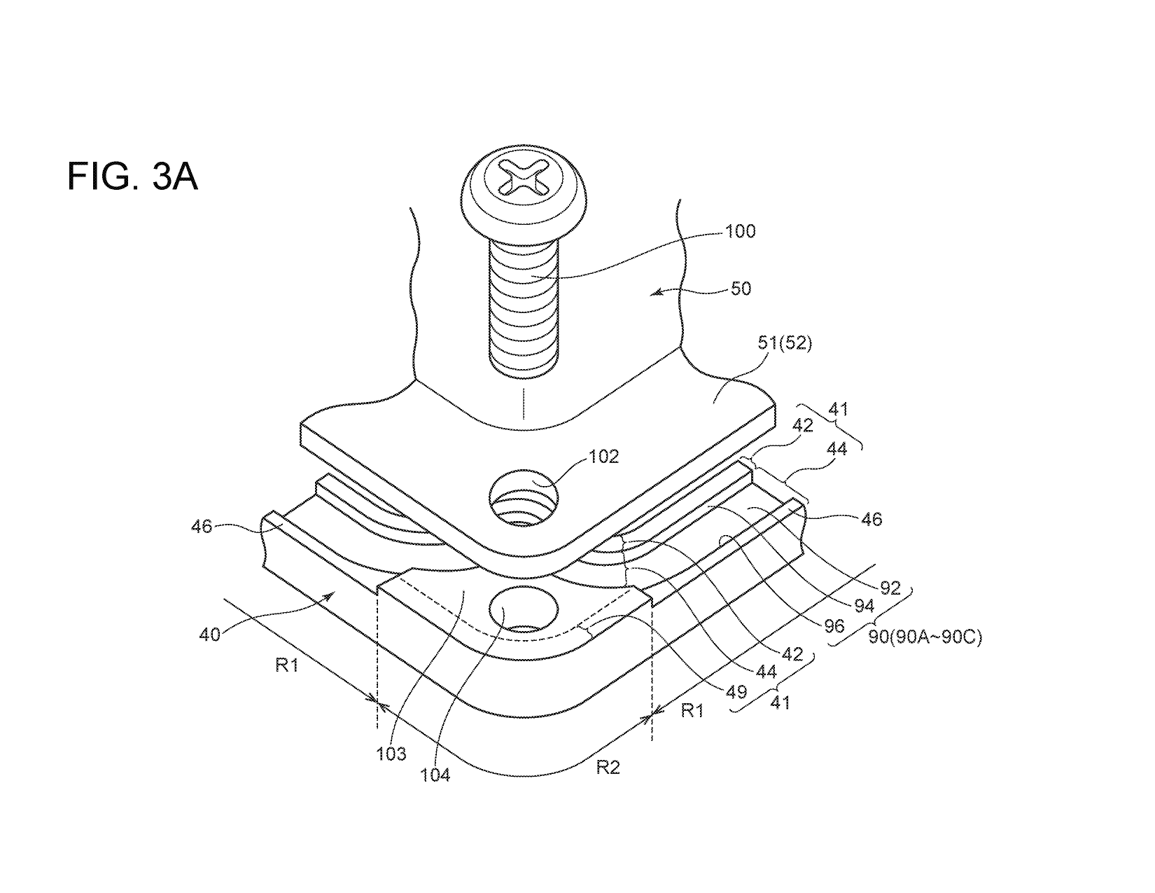

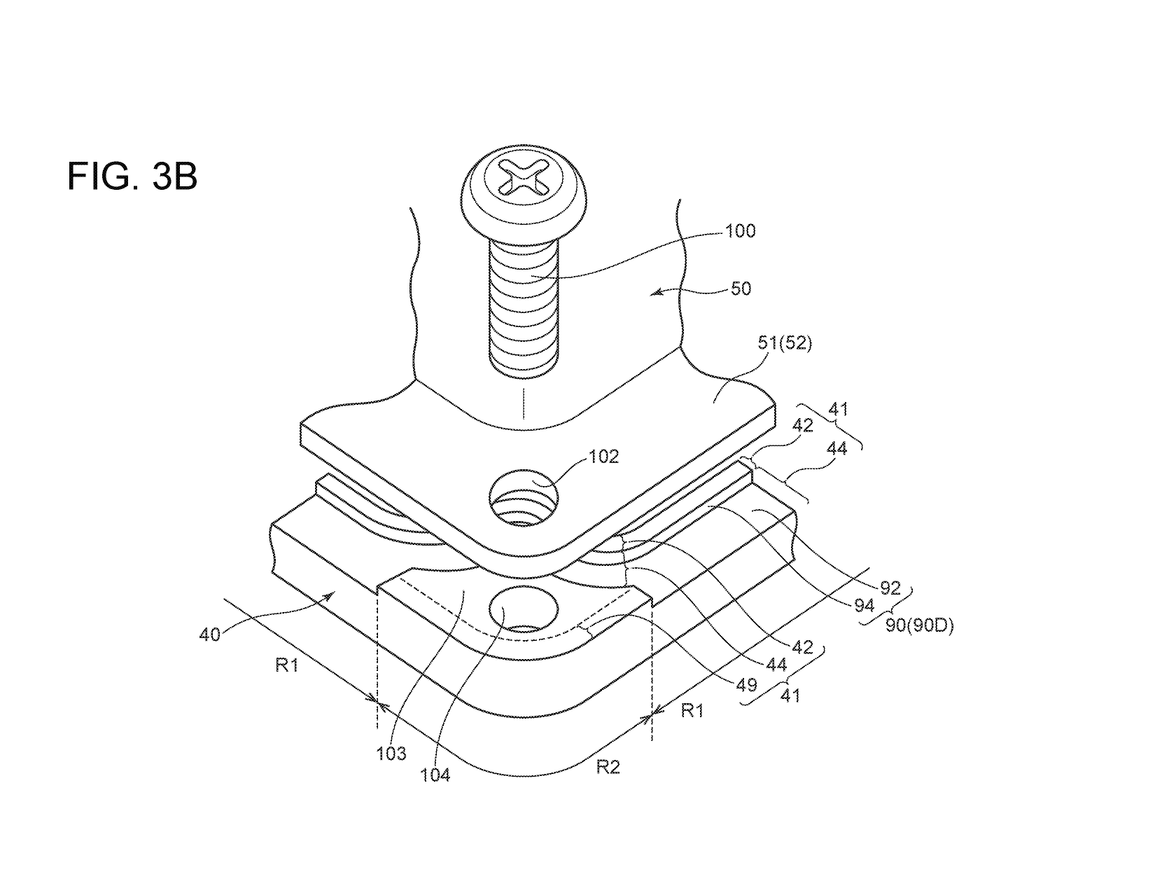

FIG. 3A is an exploded perspective view showing a configuration around the fastening portion between the partition part 40 and the board cover 50 according to an embodiment. FIG. 3B is an exploded perspective view showing the configuration around the fastening portion between the partition part 40 and the board cover 50 according to another embodiment.

In FIGS. 3A and 3B, the adhesive sealant 70 is omitted.

The circuit-integrated motor 1 has a plurality of screws 100 for fastening the board cover 50 to the partition part 40. However, only one screw 100 is shown in FIGS. 3A and 3B.

The screw 100 passes through a through hole 102 disposed in the outer peripheral edge portion 51 of the board cover 50 and is screwed into a screw hole 104 disposed in a land 103 of the partition part 40. The land 103 is a raised portion formed on the opposite surface 41 so as to be flush with the contact region 42, in order to appropriately apply an axial force of the screw 100 to the outer peripheral edge portion 51 of the board cover 50 and the partition part 40.

The circumferential range of the circuit-integrated motor 1 is divided into a circumferential range R1 excluding the fastening portion between the partition part 40 and the board cover 50, and a circumferential range R2 including the fastening portion between the partition part 40 and the board cover 50.

The circumferential range R1 is a target for application of the configurations of the adhesive sealant 70 (70A to 70D) and the seal groove 90 (90A to 90D), which are described above. The circumferential range R2 is a circumferential range corresponding to the land 103 in which the screw hole 104 is disposed.

In some embodiments, as shown in FIGS. 3A and 3B, in the circumferential range R1 excluding the fastening portion between the partition part 40 and the board cover 50, the opposite surface 41 of the partition part 40 includes the contact region 42 and the outer peripheral region 44 located on the outer peripheral side of the contact region 42, and H_max < H_ref holds for the contact region 42 and the outer peripheral region 44.

In contrast, in the circumferential range R2 including the fastening portion between the partition part 40 and the board cover 50, the opposite surface 41 of the partition part 40 further includes a seal region 49 externally surrounding the screw hole 104, on an outer peripheral side relative to the outer peripheral region 44 in which the seal groove 90 is formed. The seal region 49 is a part of an upper surface of the land 103 and is flush with the contact region 42.

In the seal region 49, a thin-film adhesive layer is formed by applying and curing the liquid gasket. That is, the land 103 of the partition part 40 faces the board cover 50 via the adhesive layer, in the seal region 49.

In the embodiments shown in FIGS. 3A and 3B, the seal region 49 is formed on the opposite surface 41 over the entire circumferential range R2. Therefore, both circumferential ends of the adhesive layer formed in the seal region 49 are substantially connected to the adhesive sealant 70 (70A to 70D) of the outer peripheral region 44 in the circumferential range R1.

In the exemplary embodiment shown in FIG. 3A, the partition part 40 has the outer peripheral protruding portion 46, and the both circumferential ends of the adhesive layer formed in the seal region 49 are each connected to the thinnest portion 76 of the adhesive sealant 70 (70A to 70C) of the outer peripheral region 44 in the circumferential range R1.

In contrast, in the exemplary embodiment shown in FIG. 3B, the partition part 40 does not have the outer peripheral protruding portion 46, and the both circumferential ends of the adhesive layer formed in the seal region 49 are each connected to the body portion 75 of the adhesive sealant 70 (70D) of the outer peripheral region 44 in the circumferential range R1.

The characteristic configurations of the circuit-integrated motor 1 (1A to 1C) according to some embodiments described above are summarized as follows.

[1] A circuit-integrated motor (1; 1A to 1C) according to at least some embodiments of the present invention, includes: a motor (10); a control board (20) for controlling the motor (10); a casing (30) including a partition part (40) dividing a board chamber (21) for housing the control board (20) from a placement space for the motor (10), and a board cover (50) disposed opposite the partition part (40) with the control board (20) interposed therebetween. On an outer peripheral side of the control board (20), an opposite surface (41) of the partition part (40) to the board cover (50) includes: a contact region (42) in contact with an outer peripheral edge portion (51) of the board cover (50); and an outer peripheral region (44) located on an outer peripheral side of the contact region (42) and formed with a seal groove (90; 90A to 90D) recessed from the contact region (42). The circuit-integrated motor (1; 1A to 1C) further includes an adhesive sealant (70; 70A to 70D) filled into the seal groove (90; 90A to 90D) of the partition part (40) to seal a gap between the partition part (40) and the board cover (50). The opposite surface (41) of the partition part (40) to the board cover (50) has a maximum protrusion height H_max from a groove bottom (92) of the seal groove (90; 90A to 90D) toward the board cover (50) in the outer peripheral region (44), which is less than a protrusion height H_ref from the groove bottom (92) toward the board cover (50) in the contact region (42).

According to the above configuration [1], since H_max<H_ref, it is possible to control a flow direction of the liquid gasket applied to the seal groove (90; 90A to 90D) within the seal groove (90; 90A to 90D), such that the liquid gasket is pushed out to the outer peripheral side. Therefore, the adhesive sealant (70; 70A to 70D) formed by solidification of the liquid gasket effectively seals a gap at a mating surface between the board cover (50) and the partition part (40), making it possible to improve gap corrosion resistance of the circuit-integrated motor (1; 1A to 1C).

Further, according to the above configuration [1], compared to a case where the liquid gasket is caused to flow to the inner peripheral side within the seal groove (90; 90A to 90D), a sufficient amount of the liquid gasket can be supplied to an outermost peripheral portion of the gap between the board cover (50) and the partition part (40), making it possible to effectively suppress gap corrosion in the circuit-integrated motor (1; 1A to 1C). Furthermore, a risk of the liquid gasket entering into the board chamber (21) is reduced, making it possible to enhance reliability of the circuit-integrated motor (1; 1A to 1C). For example, when a vent is provided in the partition part (40) to ensure ventilation of the board chamber (21), the liquid gasket can be prevented from blocking the vent.

[2] In at least some embodiments, in the above configuration [1], the partition part (40) has an outer peripheral protruding portion (46) protruding from the groove bottom (92) of the seal groove (90; 90A to 90C) toward the board cover (50), in the outer peripheral region (44) of the opposite surface (41), and H_max is a protrusion height of the outer peripheral protruding portion (46) from the groove bottom (92).

According to the above configuration [2], since the gap between the board cover (50) and the partition part (40) is narrowed in the outer peripheral protruding portion (46), outflow of the liquid gasket from the seal groove (90; 90A to 90C) to the outer peripheral side can be made uniform in the circumferential direction. Further, since the maximum protrusion height H_max of the outer peripheral protruding portion (46) is less than H_ref, for the reason described in the above [1], the effect of improving the gap corrosion resistance of the circuit-integrated motor (1; 1A to 1C) can also be obtained by controlling the flow direction of the liquid gasket to the outer peripheral side.

[3] In some embodiments, in the above configuration [2], a corner portion (47) of the outer peripheral protruding portion (46) on an outer peripheral side has a curved shape.

According to the above configuration [3], since the corner portion (47) of the outer peripheral protruding portion (46) on the outer peripheral side has the curved shape, the gap between the board cover (50) and the partition part (40) widens in the corner portion (47), and the liquid gasket accumulates in the widened gap. Consequently, the sufficient amount of the liquid gasket that has accumulated in the outermost peripheral portion of the gap between the board cover (50) and the partition part (40) solidifies, making it possible to inhibit the adhesion of the corrosive liquid to the gap.

[4] In some embodiments, in the above configuration [2] or [3], the adhesive sealant (70; 70A to 70C) extends from the seal groove (90; 90A to 90C) beyond the outer peripheral protruding portion (46), and bulges from the gap between the partition part (40) and the board cover (50) to an outer peripheral side.

According to the above configuration [4], the adhesive sealant (70; 70A to 70C) bulging from the gap between the partition part (40) and the board cover (50) to the outer peripheral side effectively inhibits the adhesion of the corrosive liquid to the gap, making it possible to improve the gap corrosion resistance.

[5] In some embodiments, in any of the above configurations [1] to [4], the seal groove (90; 90B to 90D) is defined by at least: the groove bottom (92); and an inner-peripheral-side groove wall (94) located between the groove bottom (92) and the contact region (42) of the opposite surface (41), and defining a boundary on an inner peripheral side of the seal groove (90; 90B to 90D), and a connection (93) between the inner-peripheral-side groove wall (94) and the groove bottom (92) is formed by a concave curved surface.

According to the findings of the present inventors, even if the liquid gasket is applied to the seal groove (90) and then the liquid gasket is pressed and spread within the seal groove (90) by assembling the board cover (50) to the partition part (40), wetting and spreading of the liquid gasket may be inhibited by air bubbles remaining in the seal groove (90). In particular, when the connection between the side wall and the groove bottom of the seal groove (90) is a discontinuous corner portion, air bubbles are likely to remain near the connection.

In this regard, according to the above configuration [5], by forming the shape of the connection (93) between the inner-peripheral-side groove wall (94) and the groove bottom (92) into the concave curved surface, it is possible to promote wetting of the liquid gasket, prevent air bubbles from remaining inside the adhesive sealant (70; 70B to 70D), and improve the gap corrosion resistance.

[6] In some embodiments, in the above configuration [1] or [5], the opposite surface (41) of the partition part (40) is a flat surface (48) forming the groove bottom (92) of the seal groove (90; 90D) and reaching an outer peripheral edge of the partition part (40), in the outer peripheral region (44).

According to the above configuration [6], the maximum protrusion height H_max of the opposite surface (41) of the partition part (40) from the groove bottom (92) of the seal groove (90: 90D) in the outer peripheral region (44), which is defined in the above [1], is substantially zero, and even if the viscosity of the liquid gasket is high, the flow direction of the liquid gasket can more reliably be controlled such that the liquid gasket is pushed out to the outer peripheral side. Therefore, it is possible to effectively seal the gap at the mating surface between the board cover (50) and the partition part (40), and to improve the gap corrosion resistance of the circuit-integrated motor (1; 1A to 1C).

[7] In some embodiments, in any of the above configurations [1] to [6], the circuit-integrated motor (1; 1A to 1C) includes a plurality of screws (100) for fastening the board cover (50) to the partition part (40). The opposite surface (41) of the partition part (4) includes: a seal region (49) externally surrounding a screw hole (104) into which each of the screws (100) is screwed, on an opposite side of the screw hole (104) from the outer peripheral region (44) in which the seal groove (90; 90A to 90D) is formed, on an outer peripheral side relative to the outer peripheral region (44). The opposite surface (41) is flush in the contact region (42) and the seal region (49). The partition part (40) is bonded to the board cover (50) via an adhesive layer in the seal region (49).

According to the above configuration [7], by performing primary seal in the seal region (49) disposed on the opposite surface (41) of the partition part (40) to the board cover (50) so as to surround the screw hole (104), it is possible to effectively inhibit the entry of the corrosive liquid to the gap between the board cover (50) and the partition part (40) even when fastening by the screw (100) is performed on the outer peripheral side of the seal groove (90). Therefore, it is possible to improve the gap corrosion resistance of the circuit-integrated motor (1; 1A to 1C).

1. A circuit-integrated motor, comprising:
a motor;
a control board for controlling the motor; and
a casing including a partition part dividing a board chamber for housing the control board from a placement space for the motor, and a board cover disposed opposite the partition part with the control board interposed therebetween,
on an outer peripheral side of the control board, an opposite surface of the partition part to the board cover including:
a contact region in contact with an outer peripheral edge portion of the board cover; and
an outer peripheral region located on an outer peripheral side of the contact region and formed with a seal groove recessed from the contact region,
the circuit-integrated motor further comprising an adhesive sealant filled into the seal groove of the partition part to seal a gap between the partition part and the board cover, and
the opposite surface of the partition part to the board cover having a maximum protrusion height H_max from a groove bottom of the seal groove toward the board cover in the outer peripheral region, which is less than a protrusion height H_ref from the groove bottom toward the board cover in the contact region.

2. The circuit-integrated motor according to claim 1, wherein
the partition part has an outer peripheral protruding portion protruding from the groove bottom of the seal groove toward the board cover, in the outer peripheral region of the opposite surface, and
H_max is a protrusion height of the outer peripheral protruding portion from the groove bottom.

3. The circuit-integrated motor according to claim 2, wherein
a corner portion of the outer peripheral protruding portion on an outer peripheral side has a curved shape.

4. The circuit-integrated motor according to claim 2, wherein
the adhesive sealant extends from the seal groove beyond the outer peripheral protruding portion, and bulges from the gap between the partition part and the board cover to an outer peripheral side.

5. The circuit-integrated motor according to claim 1, wherein
the seal groove is defined by at least:
the groove bottom; and
an inner-peripheral-side groove wall located between the groove bottom and the contact region of the opposite surface of the partition part to the board cover, and defining a boundary on an inner peripheral side of the seal groove, and
a connection between the inner-peripheral-side groove wall and the groove bottom is formed by a concave curved surface.

6. The circuit-integrated motor according to claim 1, wherein
the opposite surface of the partition part to the board cover is a flat surface forming the groove bottom of the seal groove and reaching an outer peripheral edge of the partition part, in the outer peripheral region.

7. The circuit-integrated motor according to claim 1, comprising:
a plurality of screws for fastening the board cover to the partition part, wherein
the opposite surface of the partition part to the board cover includes:
a seal region externally surrounding a screw hole into which each of the screws is screwed, on an opposite side of the screw hole from the outer peripheral region in which the seal groove is formed, on an outer peripheral side relative to the outer peripheral region,
the opposite surface is flush in the contact region and the seal region, and
the partition part is bonded to the board cover via an adhesive layer in the seal region.
